(19) United States
(12) Patent Application Publication
(10) Pub. No.: US 2023/0334602 A1
(43) Pub. Date: Oct. 19, 2023

(54) SYSTEMS AND METHODS OF IMPROVING THE SAFETY AND EFFICIENCY OF EXCAVATION ACTIVITIES

(71) Applicant: One Call Concepts, Inc., Hanover, MD (US)

(72) Inventor: Randall Mark PETERSON, Hales Corner, WI (US)

(73) Assignee: One Call Concepts, Inc., Hanover, MD (US)

(21) Appl. No.: 17/719,851

(22) Filed: Apr. 13, 2022

(51) Int. Cl. G06Q 50/08; G06Q 30/00

(52) U.S. Cl. CPC G06Q 50/08; G06Q 30/016

(57) ABSTRACT

Systems and methods are described for improving the safety of excavation activities and the accuracy of excavation polygons generated by users of the system and underlying reference data. An exemplary system as described herein comprises a software module for comparing ticket and reference polygons, wherein the ticket polygons are generated by users of the system and the reference polygons are generated based on data contained within a reference database comprising parcel data, line map data, facility map data, ortho map data, road features data, water features data, a highway data, building footprint data, route data, TIGER file data and the like. Methods are described for improving ticket accuracy and underlying map data, improving user training measures, preventing safety accidents and providing historical reports on excavation activities and system effectiveness. It is an object of the invention to improve the safety of excavation activities based on ticket scoring algorithms.

### STATEMENT REGARDING FEDERALLY SPONSORED RESEARCH OR DEVELOPMENT

The invention described herein was developed without the benefit of federal funding.

### BACKGROUND OF THE INVENTION

The invention herein relates to the field of locating underground facilities in connection with excavation. Excavation notices, referred to throughout this disclosure as “tickets”, are notices that include descriptions of locational coordinates, landmarks, buildings, roads and other useful information for determining where a proposed excavation is to take place and what underground facilities and the like may be present within excavation areas, which will be referred to herein as “polygons”. Tickets are typically completed either by a customer service representative (CSR) working in a call center, which serves the owners of underground utilities within a polygon and notifies them of proposed excavation within the polygon, or a person involved in the proposed excavation activity.

Due to the manual nature of data entry, combined with the need for ongoing updates of road maps, surveys and other information sources used to map polygons, there is a long felt need in the art to provide a means for verifying the accuracy of polygons used in connection with locate operations and excavations. It is an object of the invention of the present disclosure to provide a means for accomplishing this goal using modern software-based technology. It is a further object of the invention to improve the safety of personnel working in the excavation field and provide a fast and effective means of identifying potential safety issues associated with polygons prior to the commencement of excavation activities. No such solution exists in the current state of the art.

### SUMMARY OF THE INVENTION

A system of the present disclosure comprises a database within which tickets are stored and processed in accordance with instructions provided by queuing software for delivery to the applicable facility owners. A system of the present disclosure further comprises analytical software capable of recognizing the text entered into each ticket, which includes form fields as well as free-form text comprising special instructions and the like. The form fields of each ticket contain required information that pertain to the location of the excavation, such as the names of the state, county, city or town, street address, and intersecting streets, which are captured and analyzed along with the free-form marking instructions, all of which may be stored in a database according to a system embodiment.

The analytical software of a system as described herein processes the ticket information and translates the information into a series of latitude and longitude coordinates that are combined to form a polygon, which geographically defines the described excavation area. After completing this process, the analytical software compares the polygon it created to the ticket polygon defined by the person who input the ticket information. This comparison is used to generate a numerical “score” for the ticket. Different actions can then be taken by call center personnel or others involved in the excavation or location operations based upon the ticket scores, which in some cases may prevent dangerous digging operations from taking place where the location of an underground utility such as electrical power is uncertain based on the analytical methods enabled by the system.

An added benefit of the invention of the present disclosure is the enabling of map updates, such as in cases where a system as provided is not able to create a ticket polygon based on the text on the ticket because the roads being described do not exist in the base maps used in connection with the system. Another added benefit of a system as described herein is that error trends can be identified among persons entering data, such as call center personnel or web users, and retraining may be recommended on that basis to reduce error rates. Indeed, all of the data generated through system analytics may be stored in a database to enable data export and reporting to identify different trends in the entry of ticket inputs and use system analytics to update base maps and other data sources used in ticket creation. These and other benefits of the present invention will be appreciated by one of ordinary skill in the art based on the disclosure that follows.

### BRIEF DESCRIPTION OF THE DRAWINGS

FIG. 1 illustrates an exemplary system architecture according to the present disclosure.

FIG. 2 illustrates an exemplary process flow according to the present disclosure.

FIG. 3 illustrates an exemplary score calculation matrix.

FIG. 4 illustrates screenshot of a home screen produced in accordance with the invention of the present disclosure, which allows users to select options for reporting.

### DETAILED DESCRIPTION OF THE INVENTION

The invention is that of a system and methods of improving the safety and efficiency of excavation activities by improving the accuracy of defined ticket polygons using processing steps applied to database inputs as directed by one or more specialized computer software modules in network communication with one or more databases and one or more computer processors capable of executing the instructions programmed into the software modules.

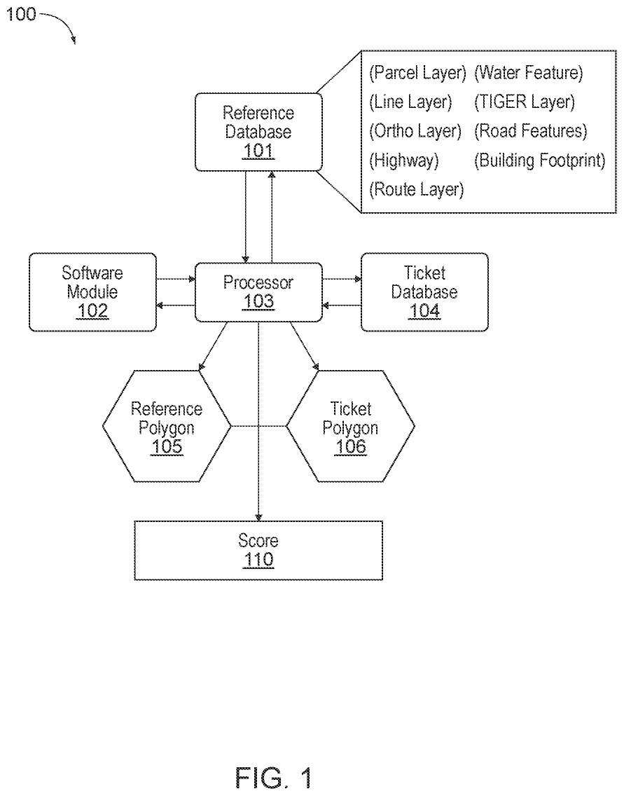

FIG. 1 illustrates a system architecture according to an illustrative embodiment 100 of the present invention. This embodiment includes a software module 102 in network communication with a processor 103 for accessing information from ticket database 104 and reference database 101 in order to generate ticket polygon 106 and reference polygon 105 for comparison according to the methods recited herein. A reference database may include data layers such as a parcel layer, line layer, ortho layer, highway layer, route layer, water features layer, TIGER file layer, road features layer and building footprint layer as discussed in more detail below. According to instructions of the software module 102, a processor 103 may generate a score 110 based on comparisons between information from the ticket database 104 and reference database 101 as discussed below, as they appear in the polygons.

One of ordinary skill in the art will appreciate that tickets are generated in order to define polygons and thereafter alert the owners of underground facilities within a polygon, for example, through call centers in communication with the facility owners, in order to locate and ensure that the owned facilities are not inadvertently damaged during an excavation operation and protect excavators against injury by way of guarding against inadvertent contact with underground utilities. As tickets are generated primarily as a result of manual data entry by persons involved in a request to locate underground facilities prior to an excavation, or by CSRs working at call centers, a system as described herein capable of comparing polygon entries against known coordinates, roadmaps and the like provides a means for gauging the accuracy of the tickets and identifying inconsistencies between ticket information and information contained in databases used to map the geographic coordinates within and around a polygon and developing a score that alerts facility owners and excavation personnel when safety issues, for example, are likely.

For this purpose, a system of the present disclosure comprises a database containing geographic information which may be processed by a connected computer processor in accordance with instructions of a software module as provided herein for the purpose of generating a polygon based on preexisting information contained within the database. Database information according to the present invention may be characterized as having various “data layers”. Each data layer represents different map data features, such as but not limited to a parcel maps, hydrographic features, and latitude and longitude coordinates. Data layers of a system of the present disclosure may comprise one or more of a parcel layer, a line map layer, a facility map layer, an ortho map layer, a road features layer, a water features layer, a highway layer, a building footprint layer, a route layer and a Topologically Integrated Geographic Encoding and Referencing (TIGER) file layer, as will be familiar to one of ordinary skill in the art. A database containing such data layers may be referred to herein as a “reference database”.

In addition to the reference database, a system of the present disclosure comprises a “ticket database”, containing information supplied as ticket data inputs. Information included in the ticket database may be pulled from form fields used in ticket data entry, such as but not limited to geographic state data, ticket number, ticket revision number, release time (the time at which the ticket is released into the analysis queue), user identification, and scores.

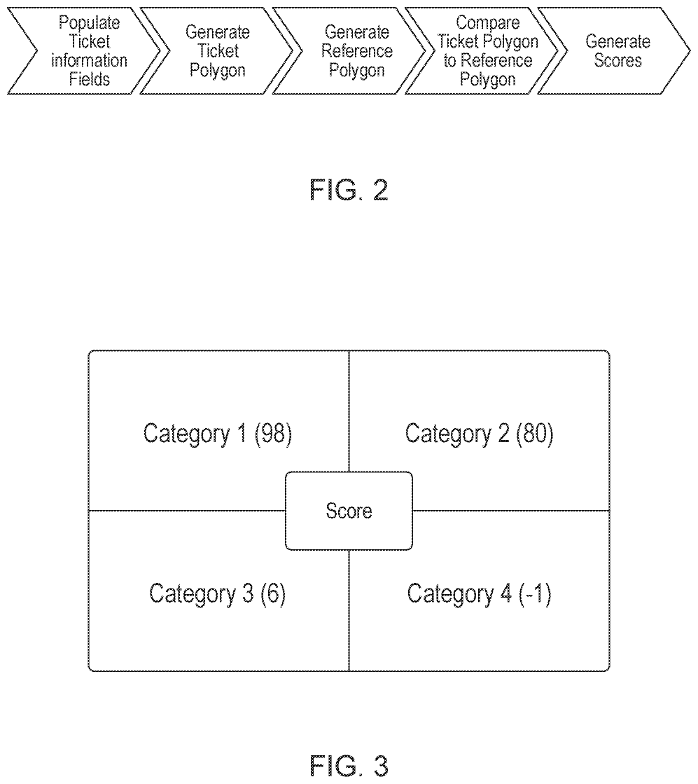

Upon release into the analysis queue, data from the ticket database, a software module of the present invention causes a processor first to classify the comparison of the ticket data to the reference data into one of four categories with respect to the polygons corresponding to each according to Table 1. Method steps as shown in FIG. 2 may include populating ticket information fields (manually or from connected mapping applications), generating a ticket polygon based on the information fields, generating a reference polygon in accordance with data processing instructions for processing of data from a reference database, comparing the ticket polygon to the reference polygon, and generating scores in various categories as described below, all in response to instructions of the software module. Scores in each category matrix, as show in FIG. 3, may be generated and weighted into an aggregate score. Each category represents a corresponding data matrix.

TABLE 1

| Category | Category Description |
|---|---|
| 1 | The reference polygon fully contains the ticket polygon |
| | created by the user. |
| 2 | The ticket polygon created by the user fully contains the |
| | reference polygon. |
| 3 | The reference polygon and the ticket polygon created by the |
| | user intersect each other. |
| 4 | The reference polygon and the ticket polygon created by the |
| | user do not intersect at all. |

Analytical instructions are then executed by a computer processor in communication with the software module in order to score each matrix according to the instructions.

A Category 1 data matrix is analyzed to generate a score based on the quantity of ticket polygons that would fit inside the reference polygon. For example, as illustrated in FIG. 3, if the area of the user ticket polygon is such that 2.1 ticket polygons would fit inside the reference polygon, a system as described herein will first round to the nearest whole number (in this case 2), and then subtract that number from a starting score of 100. In this example, the score would be 98 (100−2). The system will also calculate an alternate score based on the percentage of the ticket polygon that overlaps the reference polygon. For example, if the ticket polygon covers 80% of the reference polygon, the alternate score will be 80. If the alternate score is below 15, the analytical output will be a minimum score of 15. For a Category 2 data matrix, the scoring method is identical to that of Category 1 except that the polygons are reversed. Therefore, the score is based on the percentage of the ticket polygon that is covered by the reference polygon alternate score is equal to 100 minus the number of reference polygons that would fit inside the ticket polygon (after rounding to the nearest whole number). Again, a minimum score of 15 is generated if the same numbers are used as in the first example, with the polygons reversed.

For a Category 3 data matrix, the fact that the two polygons intersect is good, but there could be a disparity between the relative size of the two polygons. Therefore, a system of the present invention will create a score and an alternate score, the score representing the percent of the reference polygon that intersects with the ticket polygon and the alternate score representing the percent of the ticket polygon that intersects with the reference polygon. Because the two polygons do intersect, a minimum score of 6 is applied.

For a Category 4 data matrix, although the polygons do not intersect, some consideration is given to the fact that they might be close to each other. Therefore, the following criteria are applied to determine both the score and alternate score:

TABLE 2

| | |
|---|---|
| Distance between Polygons | Score and Alternate Score |

| | | |
|---|---|---|
| ≤150 | feet | 5 |
| 150-300 | feet | 4 |
| 300-450 | feet | 3 |
| 450-600 | feet | 2 |
| 600-750 | feet | 1 |
| >750 | feet | 0 |

If no valid street intersection or street address is present on the ticket, each of the score and alternate score will be set at −1.

Some but not all tickets generated in the field will contain global positioning system (GPS) coordinates. For those tickets that contain this information, a software module according to the present disclosure will cause a computer processor to prioritize the GPS coordinates over other manually entered information such as addresses, street intersections and the like, and thus the ticket polygon will be defined according to the entered GPS coordinates preferentially, then the same calculations will be carried out as described above. In addition, weight is applied to a selected reference polygon based on the tracking of factors that tend to reduce the confidence in the accuracy of the reference polygon during the creation of the database used to generate the reference database. A system of the present disclosure also tracks comments entered on tickets by users and analyzes the ticket data for spelling errors, and may automatically correct the ticket entry spellings against the reference data.

According to the methods of the present invention, if a score is 5 or less, an email is sent from a system as described herein to call center personnel alerting them that a review of the ticket should be performed to verify that the ticket is accurate. There could be a problem with the ticket polygon or with the text describing the location of the excavation. All of the information generated by a system as described herein is stored in a polygon scoring database. This data can be accessed via a web site, providing call-center personnel with a variety of reports. These reports can be used to help determine which CSRs or web users may benefit from additional training. In other words, a system as described herein can be used as a tool to help perform evaluation reviews to ensure that all users know how to best utilize the system with the correct procedures.

In addition to the use cases, such as identifying safety issues and insuring the correct utility owners are notified of excavations or determining what user training might be advantageous, a system as described herein has other potential uses. In some cases, a system is not able to create a ticket polygon based on the text of the ticket because the roads being described in the ticket do not exist in the reference database, which enables the database administrator to update the database where errors exist. This includes base map data, which evolves over time with new road constructions and the like.

In certain embodiments, web-based ticket input software may be employed, wherein a user may first create a ticket polygon, which auto populates a ticket form based on that polygon. In this case, when a user subsequently changes the text on the form, there is uncertainty as to whether these changes should result in a change to the ticket polygon, so the ticket goes into a review file of a system according to the present disclosure. A system of the present disclosure may then compare tickets against a reference database and assess whether the ticket needs modification or can be released for delivery to the facility owners.

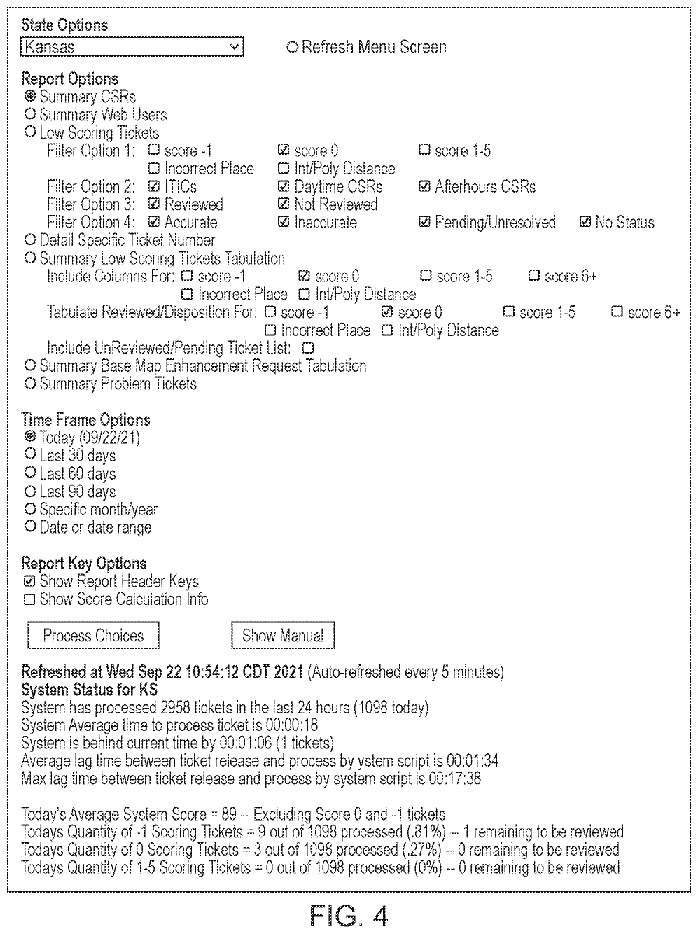

A reference database as described herein may also be used by a CSR, for example, in the creation of tickets. As the CSR populates the ticket form with information, a system as described herein collects the information entered and use the result to generate a ticket polygon for review. Additionally, summary reports may be created within the system that shows the quality of the ticket polygons created therein. Then for example, a score of −1 as shown in Category 4 in FIG. 3 indicates that no matching streets in system's base maps were found according to the CSR inputs. Additionally, a summary report may be broken into sections to provide information on tickets filed electronically (i.e., by web users), tickets filed by CSRs and tickets filed by after-hours CSRs, as can be seen in FIG. 4, which illustrates an exemplary user interface of a system according to the present invention.

As illustrated in FIG. 4, a user may select a state from which a summary report is desired, and then select options such as user type (CSR vs. web user), ticket score ranges, review status, accuracy, etc. Specific ticket numbers may also be identified and selected for review. Various tabulation options are selectable by the users as well. User settings may be refreshed, and date ranges selected for reporting periods to aid in trend analysis. System activity lists of open projects and enhancement requests may also be viewed, such as low-scoring tickets and the reasons entered for the low scored. These and other benefits of the present invention will be evident to one of ordinary skill in the art.

What is claimed:

1. A system for generating and scoring excavation polygons, the system comprising:
a software module tangibly stored on a non-transitory computer readable medium and comprising instructions, which when executed by a processor cause the processor to:
access each of a ticket database comprising a plurality of information fields corresponding to tickets and a reference database comprising a plurality of data layers;
generate a ticket polygon corresponding to a ticket and a reference polygon comprising latitude and longitude coordinates corresponding to the geographic location of the ticket;
compare the ticket polygon to the reference polygon; and
generate a score falling within one of four categories;
wherein reference polygon contains at least a portion of the ticket polygon for the first category;
the ticket polygon contains at least a portion of the reference polygon for the second category;
the reference polygon and the ticket polygon intersect for the third category; and
the reference polygon and ticket polygon do not intersect for the fourth category.

2. The system of claim 1, wherein the information fields are input into the system by a user of the system via a user interface.

3. The system of claim 1, wherein the data layers are selected from the group consisting of a parcel layer, a line map layer, a facility map layer, an ortho map layer, a road features layer, a water features layer, a highway layer, a building footprint layer, a route layer, a Topologically Integrated Geographic Encoding and Referencing (TIGER) file layer, and combinations thereof.

4. A method of generating and scoring excavation polygons, the method comprising:
providing a system according to claim 1;
populating information fields by entering information into a user interface to generate a ticket polygon;
comparing, according to instructions of a software module according to claim 1, the ticket polygon to a reference polygon to generate a score falling within one of the four categories according to claim 1.

5. The method of claim 4, wherein the reference polygon comprises data layers selected from the group consisting of a parcel layer, a line map layer, a facility map layer, an ortho map layer, a road features layer, a water features layer, a highway layer, a building footprint layer, a route layer, a Topologically Integrated Geographic Encoding and Referencing (TIGER) file layer, and combinations thereof.

6. The method of claim 4, wherein the score falling within the first category increases as the portion of the ticket polygon contained within the reference polygon increases.

7. The method of claim 4, wherein the score falling within the second category increases as the portion of the reference polygon contained within the ticket polygon increases.

8. The method of claim 4, wherein the score falling within the third category increases as the portion of the reference polygon that intersects with the ticket polygon increases, and an alternate score is generated wherein the alternate score increases as the portion of the ticket polygon that intersects with the reference polygon increases.

9. The method of claim 4, wherein the score falling within the fourth category increases as the distance between the ticket polygon and the reference polygon decreases.

10. The method of claim 4, wherein the information fields comprise global positioning system data and that is prioritized over other data entered by a user according to the instructions of the software module.

11. The method of claim 4, further comprising sending an email alert to a user of the system according to claim 1 when a score is five or less prompting the user to verify the accuracy of the ticket polygon.

12. The method of claim 11, further comprising postponing an excavation within the ticket polygon until accuracy of the ticket polygon is verified to avoid a safety accident.

13. The system of claim 1, further comprising a review database comprising historical ticket polygons, reference polygons and scores.

14. A method of improving the accuracy of ticket polygons and reference polygons, the method comprising analyzing the review database of claim 13 and correcting inaccurate data contained therein.
